(19) United States
(12) Patent Application Publication
(10) Pub. No.: US 2011/0215718 A1
(43) Pub. Date: Sep. 8, 2011

(54) HALOGEN INCANDESCENT LAMP FOR OPERATION ON MAINS VOLTAGE

(75) Inventors: Thomas Heil, Schernfeld (DE); Heinz Lang, Schernfeld (DE); Georg Rosenbauer, Wassertruedingen (DE)

(73) Assignee: OSRAM GESELLSCHAFT MIT BESCHRAENKTER HAFTUNG, Muenchen (DE)

(21) Appl. No.: 13/127,255

(22) PCT Filed: Oct. 22, 2009
(86) PCT No.: PCT/EP09/63889

§ 371 Date: May 3, 2011

(30) Foreign Application Priority Data
Nov. 3, 2008 (DE) 10 2008 054 287.3

(51) Int. Cl. H01K 1/50

(52) U.S. Cl. 313/578

(57) ABSTRACT

A halogen incandescent lamp for operation at mains voltage is provided. The halogen incandescent lamp may include a unilaterally pinched bulb in which is accommodated a filament and a halogen-containing filling as well as an inert gas, wherein at least one bulb section disposed in the vicinity of the pinch is oval shaped, said filling containing xenon as the inert gas.

### TECHNICAL FIELD

The invention relates to a halogen incandescent lamp for operation at mains (line) voltage, by which is meant a voltage of typically 100 to 260 V.

### BACKGROUND ART

DE-A 19701792 discloses a halogen incandescent lamp with improved back reflection of an IRC coating. A neck area on an otherwise elliptical bulb is used for this purpose.

EP-A 446 460 discloses the use of glass knobs to replace the support frame.

### DISCLOSURE OF INVENTION

An object of the present invention is to provide an energy-saving halogen incandescent lamp.

This object is achieved by the characterizing features of claim 1.

Particularly advantageous embodiments are set out in the dependent claims.

According to the invention, the halogen incandescent lamp is equipped with a filament suitable for mains (line) voltage operation, i.e. so-called medium voltage operation (MV) to high voltage operation (HV) at 100 to 260 V. Such a filament is particularly long compared to halogen incandescent lamps for LV operation below 80 V. Another energy-saving feature is the use of a fill gas mixture containing xenon, in particular a xenon filling, as is known per se.

Recently, however, the price of xenon has risen sharply, so that the use of xenon has become a significant cost factor. In this regard, ways of reducing this cost factor are being explored.

An obvious way is to reduce the diameter of the lamp bulb, and therefore the fill volume, while retaining the same fill gas pressure. However, from a practical point of view, the obstacle to this approach is that today's HV halogen incandescent lamps already have very small bulb diameters and/or also that the bases are standardized (e.g. G9 base) and cannot be downsized accordingly. Another obvious way is to increase the wall thickness of the bulb so that, although the external diameter remains the same, the internal volume of the bulb is reduced. However, the disadvantage of this is that greater wall thicknesses make the bulb glass much more difficult to process, especially in terms of the heating and subsequent pinching.

Another way of using less xenon fill gas is to reduce the fill pressure, but this likewise reduces the lamp quality or more specifically the operating life.

The volume is therefore inventively reduced by flattening an originally cylindrical bulb on two sides in at least one section near the pinch so that it resembles an oval in cross section, with two broad sides and two strongly curved narrow sides. As a result, there is no constraint as regards the diameter of the bulb, like in the prior art. The disadvantage of this is that the distance between the lead-in wires would have to be reduced in this area, thereby making flashovers and arcing more likely. This is particularly undesirable for HV operation.

The filament in this case is preferably bent U-shaped, V-shaped or W-shaped, but can also be disposed axially.

However, as this flattening only saves a limited amount of volume, as the long filament has to be accommodated therein, this being implemented nowadays by glass knob technology as described in EP 446 460, it is expedient to explore additional ways of reducing the volume.

A very effective additional volume-reducing measure is to taper a section of the bulb near the pinch. This taper is applied to the broad side so as to produce effectively a ramp between pinch and central section of the volume. A preferred angle of taper with respect to the lamp axis is 20 to 60°.

An alternative or also additional measure in the region near the pinch is an indentation or taper disposed parallel or transversely to the axis and extending from the pinch toward the center of the bulb. Depending on the depth and width of the indentation, considerable volume savings are provided. This taper is a flattening of the bulb so that wall sections opposite one another are brought closer together. The clearance between the coil and the front taper is preferably no less than the smallest lateral clearance between the coil and the bulb wall. Ideally a slightly bulbous front contour of the bulb can be selected so that, after any coil movement during service, the coil-to-bulb clearance does not become too small.

Another volume-reducing measure is a taper in the region of the end opposite the pinch. This second end is provided with an exhaust pip. In a “shoulder region”, the wall of the cylindrical bulb is usually angled at approximately 90° to the exhaust pip. However, it has been found that with suitable shaping during bulb manufacture it is possible to reduce the volume considerably in said shoulder region by implementing such a “shoulder slope” by tapering the second end, from the cylindrical central section, to produce a shoulder slope of approximately 30 to 70° with respect to the exhaust pip.

The lamp preferably has so-called retaining knobs for securing the filament at at least one, preferably two or three points. These knobs are preferred not only because they minimize the support frame costs, but especially because the knobs likewise save volume. Said knobs are preferably hade as flared out as possible. Said funnel-shaped widening is implemented mainly in the longitudinal axis, but also transversely to the lamp axis. The longitudinal extension of the funnel is more than 20% greater than the transverse extension.

Because of its irregular contour, this lamp is on the whole unsuitable for IRC coating, the main focus of the application being rather that of providing an inexpensive energy-saving alternative to normal incandescent lamps which are known to be very low priced. The use of xenon is attractive for such a mass-produced article only in the context of volume reduction.

A lamp is preferred which incorporates as many as possible, if not all, of the preferred measures.

Of particular preference here is a design with U-shaped or V-shaped filament which is fixed at one point by means of glass knob technology. A plurality of fixings, in particular two or three fixings, using glass knob technology are likewise possible, as this likewise achieves volume reduction.

The volume-reduced bulb can be implemented for example by means of larger heating zones and additional pinching tools on the pinching machine and the knobbing machine, so that bulb shaping can be carried out as early as the pinching stage. However, some or all of the bulb volume reduction measures can also be carried out in advance even during bulb shaping on the initial bulb but also subsequently after pinching on the unexhausted finished bulb.

Basically, however, no inflation of the bulb is performed in this situation, as this is the very opposite of what is aimed for. Using the additional pinching tools or solely the “flame pressure” of the gas heating burners, the volume of the bulb is suitably reduced at the same time. Some or all of the volume-reducing measures can in particular also accompany the applying of the knobs.

As these are low-wattage miniature lamps, only a limited amount of space is available for volume saving, as e.g. the halogen cycle must also be kept intact and because the thermal load must not become too high. For this reason, careful coordination of all the measures is required.

It has been found in practice that the basic design of the oval bulb can best be implemented in conjunction with glass knobs similarly to EP-A 446 460, or even knobbed quartz bars and knobbed quartz tubes similarly to WO-A 2007/079629. These two measures ideally complement one another, as the bridging length for the knobs or quartz bars can be reduced by the oval bulb.

Basically, however, the volume-saving steps “sloping bulb shoulders at an angle of 30-70°”, “oval bulb” and “tapering near the pinch” can also be implemented for halogen incandescent lamps with filament support frame.

An embodiment optimized for thermal load is obtained by tapering an underlying section of the bulb close to the pinch in the manner described, thereby making it oval-shaped, while a middle section thereabove, which can be provided with knobs, attains the original diameter of the bulb tube, i.e. is cylindrically shaped or approximates to this shape, e.g. is modified by the knobs.

Depending on the embodiment, this altogether results in a volume saving of 10 to 35% compared to a conventional bulb, a typical value being 20%. This saving is directly reflected in a lower xenon fill gas requirement.

However, although the application of an IRC coating is not ruled out in principle, the design is not optimized to that end.

A normal fill pressure of the xenon gas, whereby xenon is usually used with a smaller amount of added nitrogen, is 2 to 8 bar, with a typical value being around 4 bar. A usual halogen additive, as is known per se, is also used as a filling. As well as pure Xe, an Xe—N₂ mixture or other xenon/krypton/argon noble gas mixture is used as the inert gas, mainly in the presence of small quantities of nitrogen.

The wall thickness of such bulbs must not be set too great, as shaping will no longer be possible. It must be between 0.8 and 1.3 mm, preferably no less than 1.1 mm. A typical diameter of the bulb, considered as a tube in the undisturbed state, is 10 to 15 mm, preferably up to 13.5 mm. A typical volume of the bulb is 0.6 to 1.2 cm³, preferably 0.7 to 0.8 cm³.

Mains voltage is understood here as meaning a range from 100 to 260 V, in particular a value of 200 to 260 V, because it is here that the invention is at its most advantageous, having regard to the longer filament compared to MV lamps which, however, are often produced in the same design as the HV lamps.

The wattage is preferably 10 to 100 W, the coil wire of the filament having a diameter of 13 to 100 μm and the luminous sections being double-coiled. The ends of the filament are preferably single-coiled or uncoiled.

### BRIEF DESCRIPTION OF THE DRAWINGS

The invention will now be explained in greater detail with reference to a number of exemplary embodiments and the accompanying drawings, in which:

FIG. 1 shows a halogen incandescent lamp with ovally flattened bulb;

FIG. 2 shows the lamp from FIG. 1 in a perspective view;

FIG. 3 shows another exemplary embodiment with flattened bulb;

FIG. 4 shows another exemplary embodiment with flattened and ramped bulb;

FIG. 5 shows another exemplary embodiment with tapered shoulders and indentation;

FIG. 6 shows another exemplary embodiment with flat bulb section and large funnel widening;

FIG. 7 shows another exemplary embodiment with oval bulb section slightly enlarged in the longitudinal direction;

FIG. 8 shows another exemplary embodiment with flattened bulb;

FIG. 9 shows another exemplary embodiment with flattened bulb in different views and with different details (9a to 9e).

### PREFERRED EMBODIMENT OF THE INVENTION

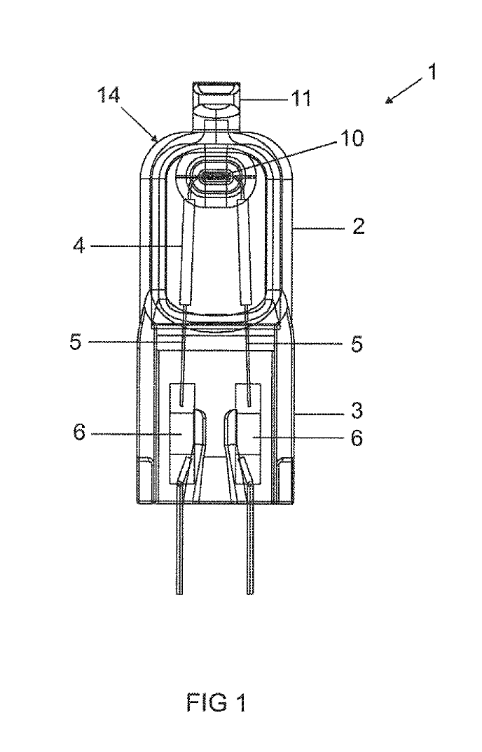

An exemplary embodiment of a halogen incandescent lamp 1 is shown in FIG. 1. It has a quartz glass bulb 2 sealed with a pinch 3. Mounted inside the bulb is a U-shaped filament 4 which is connected via two internal lead-in wires 5 to respective foils 6 in the pinch 3. The lead-in wires are typically of tungsten or molybdenum or similar and have a diameter of 13 to 100 μm depending on the wattage of the lamp. The bulb contains a usual halogen-containing filling together with xenon at a cold fill pressure of 3 to 4 bar. The type of halogen-containing filling is irrelevant here. The foil 6 is of molybdenum in each case.

The bulb has an axially disposed knob 10 for retaining the filament. It has an exhaust pip 11 at the opposite end from the pinch.

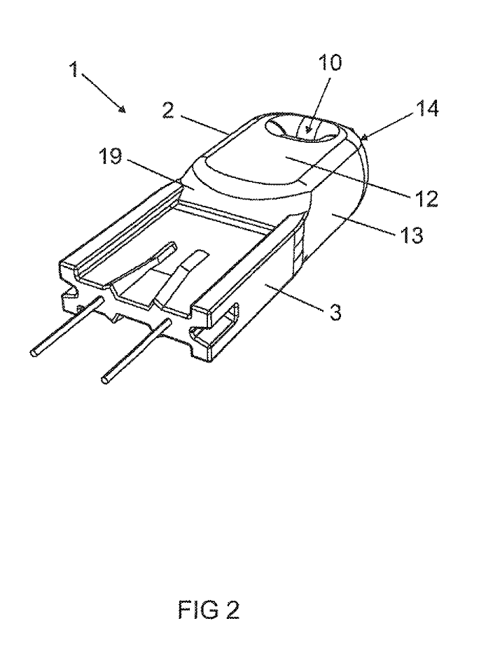

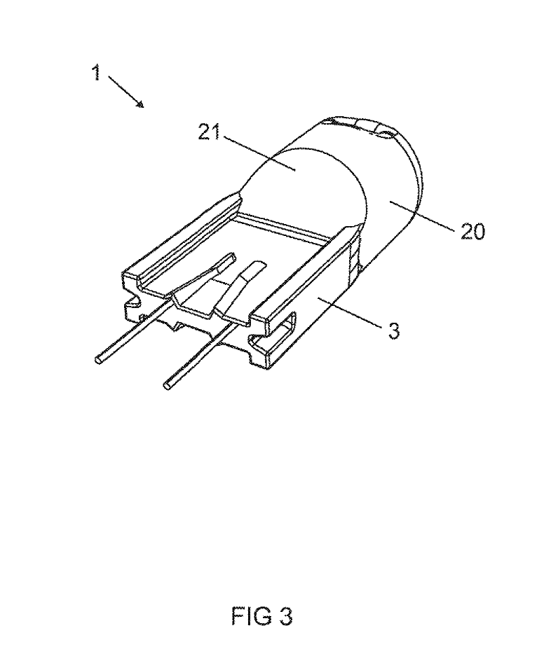

FIG. 2 shows the lamp 1 in a perspective view. The bulb 2, which was originally produced in cylindrical form from a tube, is pressed flat into an oval. This means that it has two plane broad sides 12 and two curved narrow sides 13. The knob 10 is at the upper end of the oval region and is incorporated therein. The bulb shoulder section 14 leading to the exhaust pip 11 is at right-angles to the axially parallel wall of the oval section. The bulb has a slight taper 19.

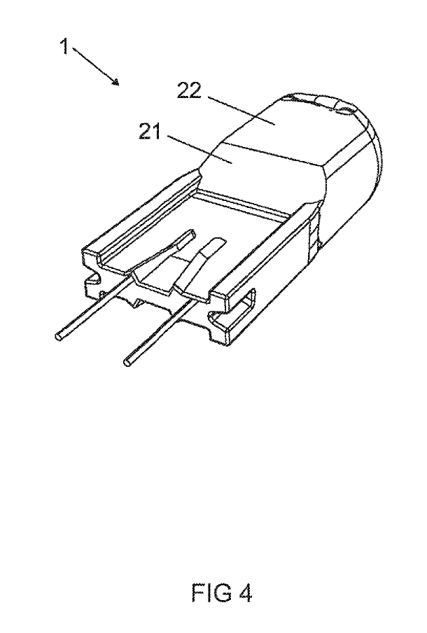

FIG. 3 shows another exemplary embodiment of a halogen incandescent lamp 1, wherein the bulb has a cylindrical central section 20 and ramps 21 sloping away from the pinch 3 which define the broad sides. The slope angle of the ramp 21 is preferably 40 to 50°.

With particular preference, said ramp 21 acts in conjunction with an oval section 22 of the bulb so as to produce a greater volume reduction. This example is shown in FIG. 4.

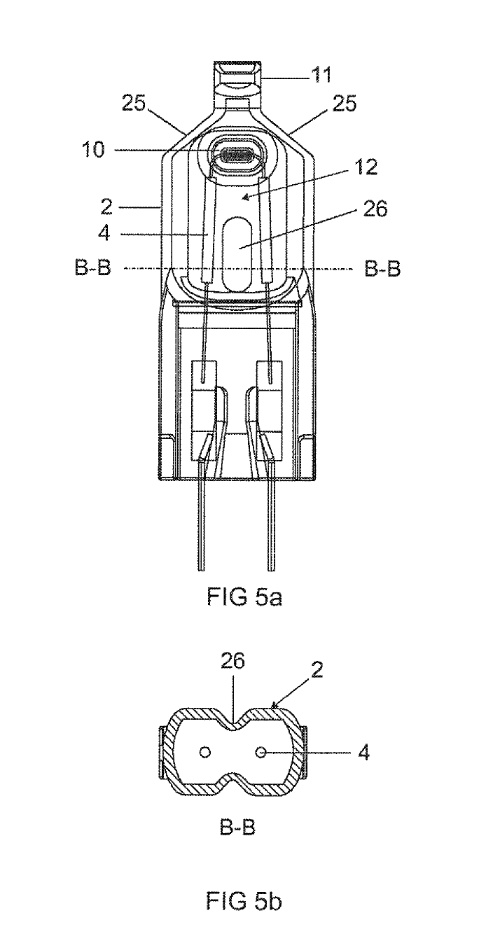

FIG. 5 shows another exemplary embodiment having a bulb 2 with an oval section 12, this time combined with a tapered shoulder section 25 leading to the exhaust pip 11. In the area near the pinch, this embodiment also has an axial indentation 26 which reduces the volume still further. Said indentation is present on each broad side, without the inner walls of the two indentations touching.

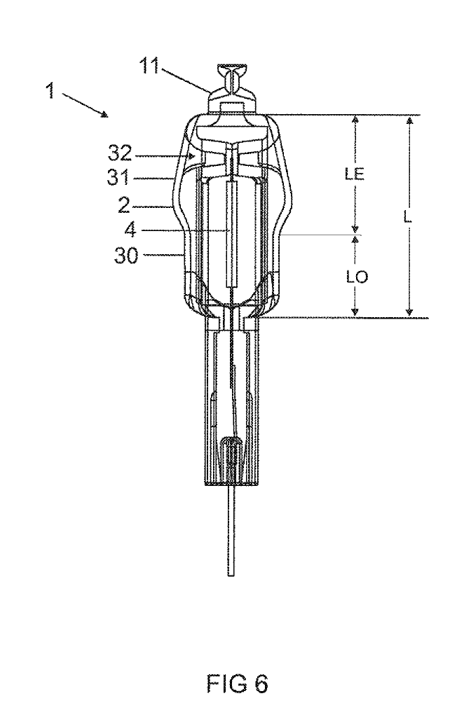

Lastly FIG. 6 illustrates an exemplary embodiment showing a side view of a bulb 2 rotated through 90° wherein a region 30 near the pinch is oval shaped, while a region 31 away from the pinch has a larger outer dimension. However, the region 31 is effectively reduced in volume by a pronounced funnel-shaped knob 32 for retaining the filament 4. In this variant it is preferable if the length L of the bulb, calculated from the end of the pinch 3 to the start of the exhaust pip 11, is subdivided into two regions such that the oval region 30 of length LO extends over about 30 to 45% of the length L, while the funnel-dominated section makes up the remainder LE of the length L.

The lamp is manufactured using specially shaped lengthened pinching jaws in order to produce the oval section as shown in FIG. 6. In the case of an elongated oval section similar to that shown in FIG. 1, it is better not to reshape the initially cylindrical bulb until later. The shoulder slope 25 can best be formed by heating up a larger bulb area when the bulb dome is curled over from the cylindrical tube. The funnel-shaped knob 32 can be formed both prior to the main pinch and after the main pinch.

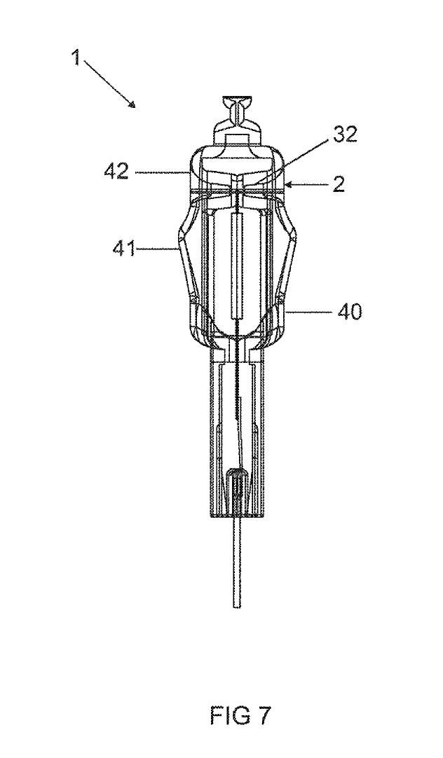

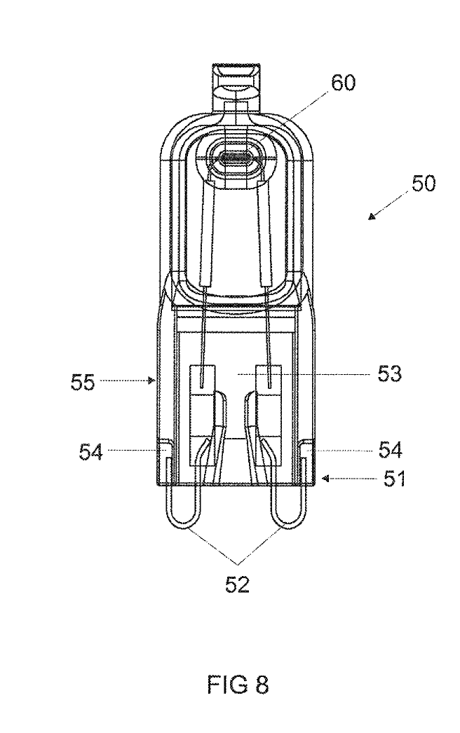

FIG. 7 shows another exemplary embodiment similar to FIG. 6, showing a side view of a bulb 2 rotated through 90° wherein a short region 40 near the pinch is oval shaped, while a region 41 away from the pinch has a larger outer dimension. Another oval region 42 is effectively reduced in volume by a funnel-shaped knob 32 for retaining the filament 4.

FIG. 8 shows a halogen incandescent lamp 50 with glass base 51, wherein the lead-in wires 52 are bent back laterally to the pinch 53 where they are fixed in slots 54 on the narrow sides 55 of the pinch. In this example it is possible to produce the “indented” bulb without using a forming tool. Instead, the bulb is indented in the vicinity of the pinch solely by suitably adjusting the flame pressure of the outflowing combustion gases during pinching.

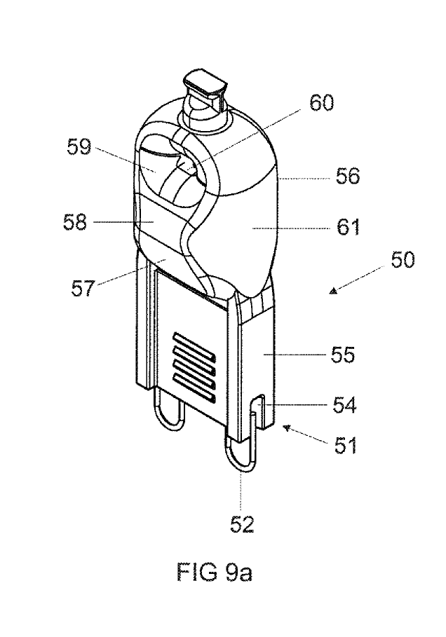

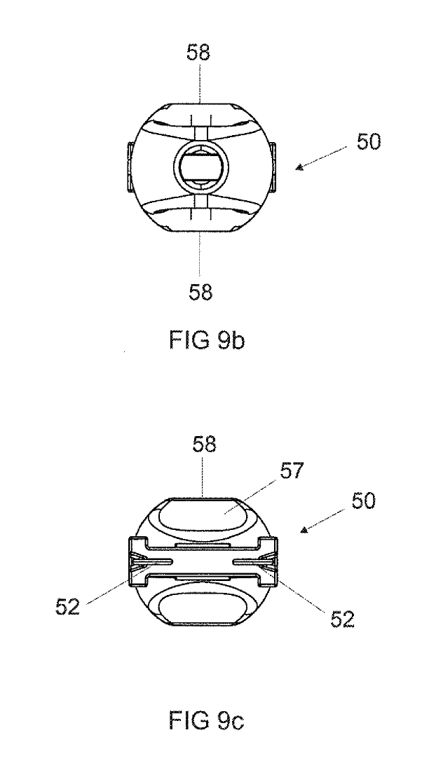

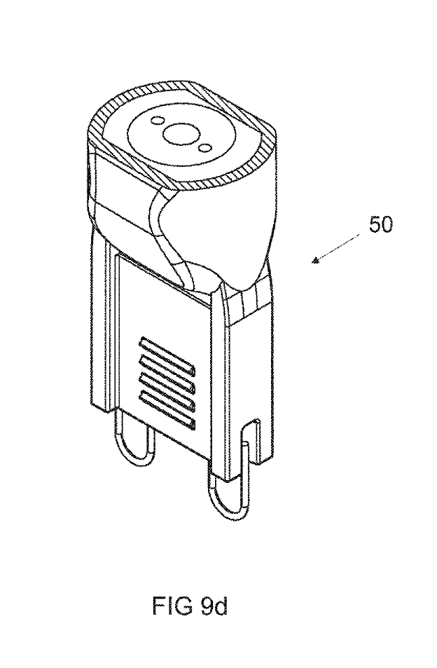

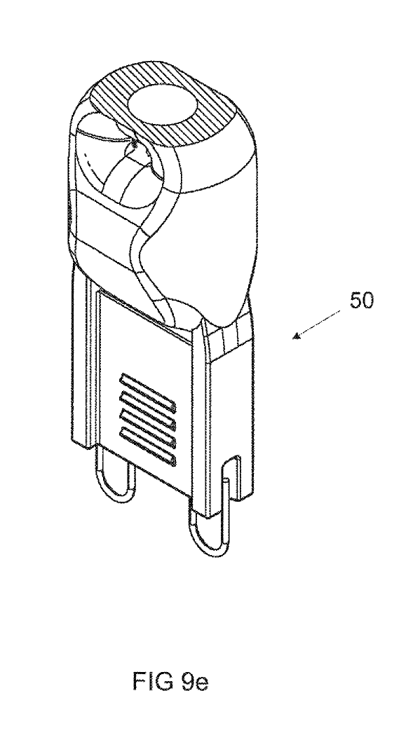

FIG. 9 shows various views of a similar example. FIG. 9a shows the halogen incandescent lamp 50 in a perspective view. It has a glass base 51 similar to the lamp in FIG. 8. The bulb 56 is rounded off in an oval shape viewed in cross section. Near the base it has a taper 57, a flattened section 58 and a transitional section 59 containing a knob 60 for fixing the filament. In the area above the narrow sides 55 of the pinch, a sub-area of the bulb remains cylindrically shaped (61). A cross section at different heights for this bulb 50 is shown in FIGS. 9d and 9e. In the area of the flattened section 58, the two “broad sides” of the bulb are straight in cross section, while the two “narrow sides” of the bulb follow circular sectors. The term “broad sides” and “narrow sides” is here oriented to the broad sides and narrow sides of the pinch. The oval is more or less deformed depending on the plane of cross section.

The maximum diameters D1 and D2 of the oval in the direction of the “broad sides” and “narrow sides” respectively are typically 10 to 12 mm for D1 (in respect of the “broad sides”) and approximately 13 mm for D2 (in respect of the “narrow sides”). The ratio D1/D2 is therefore approximately 92%. An eccentricity ratio of the two diameters, defined as V=(D2−D1)/D2, of V>0.05 should preferably be aimed for, in order that the saving due to the reduced bulb volume justifies the manufacturing cost/complexity. The maximum value here is V=0.23. A V value of up to 0.30 is easily achievable with this technology, and even up to V=0.5 is feasible.

The filling preferably contains at least 90% Xe, in particular a lower percentage of N₂ is added, amounting to approximately 3 to 10%.

Essential features of the invention in the form of a numbered listing:

1. A halogen incandescent lamp for operation at mains voltage, having a unilaterally pinched bulb in which is accommodated a filament and a halogen-containing filling as well as an inert gas, characterized in that at least one bulb section disposed in the vicinity of the pinch is oval shaped, said filling containing xenon as the inert gas.

2. The halogen incandescent lamp as claimed in claim 1, characterized in that the bulb has at least one knob for retaining the filament, preferably one to three knobs.

3. The halogen incandescent lamp as claimed in claim 1, characterized in that the filament is arranged in a U-shaped, V-shaped, W-shaped or in an axially linear manner.

4. The halogen incandescent lamp as claimed in claim 1, characterized in that the end opposite the pinch is sealed with an exhaust pip, the transitional region being implemented as a shoulder region with a slope of 30 to 70°.

5. The halogen incandescent lamp as claimed in claim 1, characterized in that, between the pinch and actual oval section with constant diameter of the broad sides, a lower region is present wherein the broad sides of the oval section are tapered.

6. The halogen incandescent lamp as claimed in claim 1, characterized in that a tapered region is present close to the pinch.

7. The halogen incandescent lamp as claimed in claim 2, characterized in that the knobs are funnel-shaped.

8. The halogen incandescent lamp as claimed in claim 7, characterized in that the longitudinal extent of the funnel is at least 20% greater than the transverse extent.

9. The halogen incandescent lamp as claimed in claim 1, characterized in that the ratio of the diameters D1 and D2 in the direction of the broad side and narrow side of the bulb has an eccentricity V=0.05 to V=0.50.

1. A halogen incandescent lamp for operation at mains voltage, the halogen incandescent lamp comprising:
a unilaterally pinched bulb in which is accommodated a filament and a halogen-containing filling as well as an inert gas,
wherein at least one bulb section disposed in the vicinity of the pinch is oval shaped, said filling containing xenon as the inert gas.

2. The halogen incandescent lamp as claimed in claim 1, wherein the bulb has at least one knob for retaining the filament.

3. The halogen incandescent lamp as claimed in claim 1, wherein the filament is arranged in a manner selected from a group consisting of: U-shaped; V-shaped; W-shaped; and in an axially linear manner.

4. The halogen incandescent lamp as claimed in claim 1, wherein the end opposite the pinch is sealed with an exhaust pip, the transitional region being implemented as a shoulder region with a slope of 30 to 70°.

5. The halogen incandescent lamp as claimed in claim 1, wherein, between the pinch and actual oval section with constant diameter of the broad sides, a lower region is present wherein the broad sides of the oval section are tapered.

6. The halogen incandescent lamp as claimed in claim 1, wherein a tapered region is present close to the pinch.

7. The halogen incandescent lamp as claimed in claim 1, wherein the at least one knob is funnel-shaped.

8. The halogen incandescent lamp as claimed in claim 7, wherein the longitudinal extent of the funnel is at least 20% greater than the transverse extent.

9. The halogen incandescent lamp as claimed in claim 1, wherein the ratio of the diameters in the direction of the broad side and narrow side of the bulb has an eccentricity V=0.05 to V=0.50.

10. The halogen incandescent lamp as claimed in claim 2, wherein the bulb has one to three knobs for retaining the filament.
